(19) United States
(12) Patent Application Publication
(10) Pub. No.: US 2010/0315504 A1
(43) Pub. Date: Dec. 16, 2010

(54) SYSTEMS, METHODS AND APPARATUS FOR TAPPING METAL ELECTROLYSIS CELLS

(75) Inventor: Edward R. Barnes, JR., Goose Creek, SC (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(73) Assignee: Alcoa Inc., Pittsburgh, PA (US)

(21) Appl. No.: 12/485,800

(22) Filed: Jun. 16, 2009

(51) Int. Cl. C25C 3/20; G01N 27/26

(52) U.S. Cl. 348/86; 204/245; 204/243.1

(57) ABSTRACT

Systems, methods and apparatus for facilitating tailored removal of liquids from electrolysis cells are disclosed. In one embodiment, a system includes a container adapted to contain molten liquid of an electrolysis cell, where the molten liquid comprises at least one of molten metal and electrolyte, a passageway adapted to view the molten liquid as it enters the body of the container, an imaging device facing the passageway, where the imaging device is adapted to obtain images of the molten liquid as the molten liquid enters the container, and a display in communication with the imaging device, where the display is adapted to depict the molten liquid via the images obtained by the imaging device. When the molten liquid transitions from molten metal to electrolyte, flow of liquid into the container may be adjusted.

### BACKGROUND

An electrolysis cell is a container containing an electrolyte through which an externally generated electric current is passed via a system of electrodes (e.g., an anode and cathode) in order to change the composition of a material. For example, an aluminum compound (e.g., Al₂O₃) may be decomposed into pure aluminum metal (Al) via an electrolysis cell. After the metal is produced, it is generally removed from the cell via a crucible and vacuum suction system.

### SUMMARY OF THE DISCLOSURE

Broadly, the present disclosure relates to systems, methods and apparatus for removing materials (e.g., liquids) from metal electrolysis cells. In one aspect, a system includes a container adapted to contain molten liquids of an electrolysis cell, a passageway adapted to view the molten liquid as it enters the body of the container, an imaging device facing the passageway that is adapted to obtain images of the molten liquid as the molten liquid enters the container, and a display in communication with the imaging device, where the display is adapted to depict the molten liquid via the images obtained by the imaging device.

The imaging device may be adapted to obtain images of the molten liquid as viewed via the passageway. The images may be of sufficient clarity to enable discernment between transition of the molten liquid from a first type of liquid to a second type of liquid. For example, a first type of liquid may be molten metal, and a second type of liquid may be electrolyte. As the images are displayed via the display, one may be able to discern transition of the liquid from molten metal to electrolyte. A switch configured to adjust (e.g., slow, quicken, and/or terminate) the flow of molten liquid into the body of the container may be located proximal the display. Thus, one may activate the switch while viewing the display, thereby facilitating adjustment of the removal of molten liquid from the electrolysis cell. In other words, when the liquid changes from an amount (e.g., a predetermined amount) of a first type to an amount (e.g., a predetermined amount) of a second type, removal of the liquid may be adjusted, which may facilitate efficient fluids removal operations. Thus, efficient removal of liquid of a first type (e.g., metal) may be effected, and with limited or restricted removal of liquid of a second type (e.g., electrolyte).

In one embodiment, the system includes an image processor in communication with the imaging device. The image processor may be configured to receive images obtained by the imaging device. The image processor may be configured to convert at least some of the images into imaging data. The system may include a data analyzer that is configured to analyze the imaging data associated with the images. The data analyzer may determine when the imaging data is representative of a predetermined amount of electrolyte in the molten liquid. The data analyzer may be in communication with the switch, and the switch may be activated when the data analyzer determines that the imaging data is representative of a predetermined amount of electrolyte in the molten liquid so as to adjust flow of liquids into the container.

The passageway may be located between the imaging device and the molten liquid. In one embodiment, the passageway is located proximal a top portion of the container. In one embodiment, the passageway is integral with at least a portion of the container. In one embodiment, the passageway may include first and second portions, each having differing diameters. In one embodiment, the first portion is proximal the inside of the container, and the second portion is proximal the outside of the container. In one embodiment, the ratio of the first diameter to the second diameter is from about 0.25:1 to about 20:1. The imaging device may be adapted to obtain suitable images of the molten liquid via the passageway, despite these differing diameters. In one embodiment, the passageway may be at an angle relative to the top surface of the molten liquid in the container so that the molten liquid can be viewed via the passageway.

The container may be any container adapted to contain molten materials. For example, the body of the container may be adapted to contain molten liquids. The spout of the container may be adapted to receive molten liquid of an electrolysis cell and pass the molten liquid into the body of the container. In one embodiment, the molten liquid of the electrolysis cell comprises molten metal and electrolyte.

Methods relating to the removal of fluids from an electrolysis cell are also provided. In one aspect a method includes (a) flowing molten liquid of an electrolysis cell into a container, where the molten liquid comprises at least one of molten metal and electrolyte, (b) obtaining images of the molten liquid with an imaging device as the molten liquid enters the body of the container, and (c) depicting, on a display, the molten liquid via the images obtained by the imaging device. The method may include adjusting the flow of molten liquid into the body of the container (e.g., in response to the depicting step (c)) when the molten liquid transitions from a first type of liquid to a second type of liquid. In one embodiment, the adjusting step comprises activating a switch proximal the display via an operator viewing the display.

In one embodiment, the obtaining images step may include focusing an imaging device on a molten liquid through a passageway containing a first portion and a second portion, where the first portion of the passageway comprises a different diameter than a second portion of the passageway. In one embodiment, the images are of sufficient clarity to enable discernment between transition of the molten liquid from a first type of liquid to a second type of liquid.

In one embodiment, the obtaining step may include converting at least some of the images into imaging data. In one embodiment, the obtaining step may include determining when the imaging data is representative of a predetermined amount of electrolyte in the molten liquid. In one embodiment, the determining step may include analyzing the imaging data associated with the images. In one embodiment, the method may include activating, concomitant to the determining step, a switch to adjust the flow of molten liquid into the body of the container.

Various ones of the inventive aspects noted hereinabove may be combined to yield various systems, methods and apparatus for facilitating tailored and selective removal of liquids from electrolysis cells. These and other aspects, advantages, and novel features of the disclosure are set forth in part in the description that follows and will become apparent to those skilled in the art upon examination of the following description and figures, or may be learned by practicing the disclosure.

### BRIEF DESCRIPTION OF THE DRAWINGS

FIG. 1 is a schematic view of one embodiment of a container and imaging system useful in accordance with the present disclosure.

FIG. 2 is a schematic view of one embodiment of an optional image processing system usable with the system of FIG. 1.

FIG. 3 is a flow chart illustrating some embodiments of methods useful in obtaining images to facilitate determination of a molten liquid content.

### DETAILED DESCRIPTION

Reference will now be made in detail to the accompanying drawings, which at least assist in illustrating various pertinent embodiments of the present disclosure.

The instant disclosure relates to systems, methods, and apparatus for viewing and obtaining images of liquids (e.g., molten aluminum) while extracting the liquids from an electrolysis cell and into a container. These systems, methods, and apparatus may include a passageway, an imaging device facing the passageway, and a display in communication with the imaging device to assist in viewing images of the liquid as the liquid enters the container. While viewing the display, an operator may be able to discern when the molten liquid transitions from a first type of liquid (e.g., molten metal) to a second type of liquid (e.g., electrolyte). In turn, the operator may adjust the flow of molten liquid into the container, thereby limiting the amount of the second type of liquid in the container.

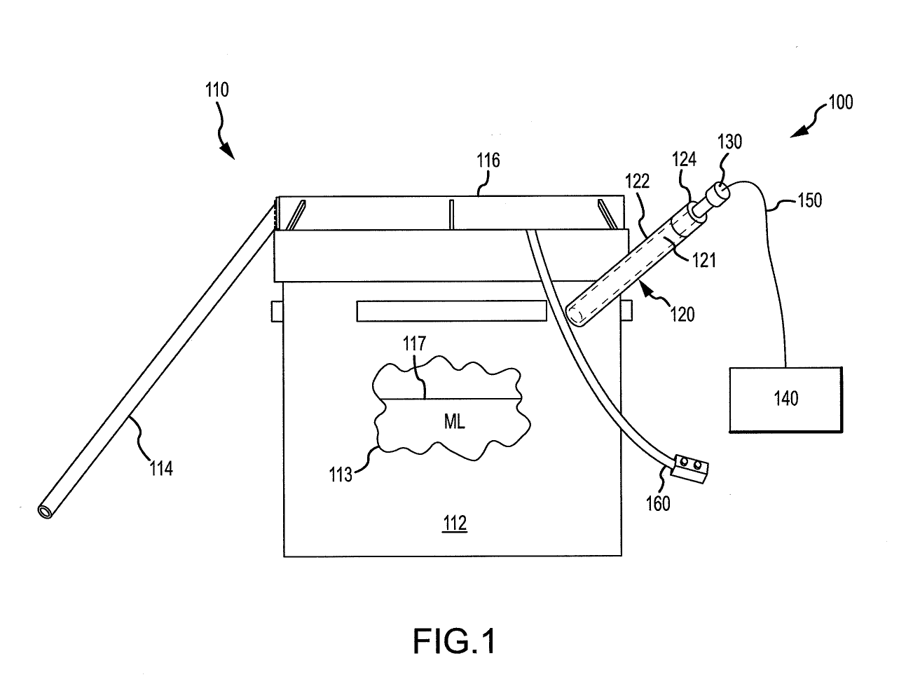

In one embodiment, and with reference now to FIG. 1, the system 100 includes a container 110 (e.g., a crucible) that has a body 112 adapted to contain molten metal of an electrolysis cell (not illustrated). A spout 114 of the container 110 is adapted to receive molten liquid (ML) of the electrolysis cell and pass the molten liquid (ML) into the body 112 of the container 110. A tube 120 containing a passageway 121 proximal a top portion 116 of the container 110 enables viewing of molten liquid (ML) as it enters the body 112 of the container 110. The passageway 121 may be at an angle relative to the top surface 117 of the molten liquid (ML) within the container 110 (illustrated via cut-away view 113 of container 110) such that the molten liquid can be viewed via the passageway 121.

In the illustrated embodiment, the passageway 121 is located between an imaging device 130 and the molten liquid (ML) within the container 110. The imaging device 130 faces the passageway 121 and is adapted to obtain images of the molten liquid (ML), via the passageway 121, as the molten liquid (ML) enters the body 112 of the container 110. In one embodiment, the imaging device 130 may obtain images of the molten liquid (ML) as viewed via passageway 121, even if the passageway 121 has a varying diameter (e.g., due to a difference in diameter between first portion 122 and a second portion 124), such that the images are of sufficient clarity to enable discernment between transition of the molten liquid (ML) from a first type of liquid (e.g., molten metal) to a second type of liquid (e.g., electrolyte).

A display 140, in communication with the imaging device 130 (e.g., via wire 150), is adapted to depict the molten liquid (ML) via the images obtained by the imaging device 130. An operator (not illustrated) may view the images on the display 140. When the molten liquid (ML) transitions from the first type of liquid to the second type of liquid as it enters the body 112 of the container 110, the operator may activate a switch 160, which is located proximal the display 140 in the illustrated embodiment, which may be configured to adjust the flow of molten liquid (ML) into the body 112 of the container 110. For example, the switch 160 may slow, increase, and/or terminate the flow of molten liquid (ML) into the body 112 of the container 110 (e.g., by changing the pressure) concomitant to the extraction of liquids from the electrolysis cell. The display 140 and/or switch 160 may be located proximal the container 110, or may be located remote of the container (e.g., in a control room).

In one embodiment, the flow of liquids is adjusted when the liquid contains a predetermined amount of liquid of a first and/or second type. In one embodiment, the flow of liquid into the container is at a first rate when the liquid contains a first amount of a first type of liquid. For example, when the liquid flowing into the container includes at least 99% molten metal, the liquid may flow into the container at a relatively quick flow rate. When the incoming liquid contains less than 99% molten metal (i.e., at least 1% electrolyte), the flow of liquid into the container may be adjusted and the liquid may flow into the container at a slower flow rate, or may be terminated. In one embodiment, the flow rate of liquid into the container is adjusted and/or terminated when the incoming liquid includes at least 1% of a second type of liquid (e.g., electrolyte). In other embodiments, the flow rate of liquid into the container is adjusted and/or terminated when the liquid includes at least 3% of a second type of liquid, or at least 5% of a second type of liquid, or at least 7% of a second type of liquid, or at least 10% of a second type of liquid, or at least 15% of a second type of liquid, or at least 20% of a second type of liquid. In some embodiments, the flow rate of liquid into the container is terminated when the liquid includes at least 20% of a second type of liquid, or at least 30% of a second type of liquid, or at least 40% of a second type of liquid. Thus, the molten liquid (ML) in the container 110 may include relatively little (e.g., ≦10%, or ≦7%, or ≦5%, or ≦3%, or ≦1%) amount of liquid of a second type.

As noted, liquid entering the container 110 may be viewed via the passageway 121. The diameter of the passageway 121 may be any size suitable to enable viewing of molten liquid (ML) as it enters the body 112 of the container 110 and/or to restrict molten liquid (ML) from splashing out of the container 110. In one embodiment, the passageway 121 includes a first portion 122 and a second portion 124, the first portion 122 having a first diameter and the second portion 124 having a second diameter. The ratio of the first diameter to the second diameter may be any combination suitable to enable viewing of molten liquid (ML) via the imaging device 130 as it enters the body 112 of the container 110 and/or to restrict molten liquid (ML) from splashing out of the container 110. For example, if the first diameter and/or the second diameter is too small, viewing the molten liquid (ML) as it enters the body 112 of the container 110 may be difficult or precluded. In another example, if the first diameter and/or the second diameter is too big, molten liquid (ML) may splash through the passageway 121 and out of the container 110 as the molten liquid (ML) enters the body 112 of the container 110. In the illustrated embodiment, the first portion 122 of the passageway 121 has a first diameter proximal the inside of the container 110, and the second portion 124 of the passageway 121 has a second diameter proximal the outside of the container 110. However, in other embodiments, the passageway 121 may have a consistent diameter. The diameter may be of an ellipse or other round shape.

In one embodiment, the ratio of the first diameter to the second diameter is about 1:1, i.e., the passageway 121 has about the same diameter along its entire length. In other embodiments, the first diameter of the first portion 122 may be different than the second diameter of the second portion 124. In one embodiment, the ratio of the first diameter to the second diameter is at least about 0.25:1. In other embodiments, the ratio of the first diameter to the second diameter is at least about 0.5:1, or at least about 0.75:1. In other embodiments, the ratio of the first diameter to the second diameter is at least about 1.5:1, or at least about 2:1, or at least about 4:1, or at least about 6:1, or at least about 8:1, or at least about 10:1, or at least about 12:1, or at least about 14:1, or at least about 16:1, or at least about 18:1, or at least about 20:1. In one embodiment, the ratio of the first diameter to the second diameter is in the range of about 0.25:1 to about 20:1.

The passageway 121 may be any shape and/or length suitable to enable viewing of molten liquid (ML) as it enters the body 112 of the container 110. For example, the passageway 121 may be linear, tortuous, polygonal, curved, or any other geometrical shape. In one embodiment, the passageway 121 has a length of not greater than about 4 feet. In other embodiments, the passageway 121 has a length of not greater than about 3.5 feet, or not greater than about 3 feet, or not greater than about 2.5 feet, or not greater than about 2 feet, or not greater than about 1.5 feet. In one embodiment, the passageway 121 has a length in the range of about 1.5 feet to about 4 feet.

In the illustrated embodiment, the passageway 121 is integral with the container 110. In other embodiments, the passageway 121 may be non-integral with the container 110.

The imaging device 130 may be any suitable device adapted to obtain images of the molten liquid (ML) as the molten liquid (ML) enters the container 110. In one embodiment, the imaging device 130 may be an analog device. In one embodiment, the imaging device 130 may be a digital device. In one embodiment, the imaging device 130 may obtain images of the molten liquid (ML) in black and white. In one embodiment, the imaging device 130 may obtain images of the molten liquid (ML) in color. In one embodiment, the imaging device 130 may include a PENTAX C22525TH, 25 MM, F 1.4, (30 mm×30 mm×37.3 mm) manual lens attached to an ARM ELECTRONICS CX420DN Color Mini Day/Night Camera. The lens and camera may be any suitable combination such that the images obtained are of sufficient clarity to enable discernment between transition of the molten liquid (ML) from a first type of liquid (e.g., molten metal) to a second type of liquid (e.g., electrolyte).

The display 140 may be any suitable device adapted to depict the molten liquid via the images obtained by the imaging device 130. For example, the display 140 may be any shape and size such that an operator may view the images on the display 140. In one embodiment, the display 140 may be a Speco Technologies 10″ LCT TFT Monitor. In some embodiments, the display 140 may be absent, such as those embodiments including an image processor, described below. In these embodiments, a display 140 may not be necessary since the image processor may facilitate determination of liquid content without the need to display images.

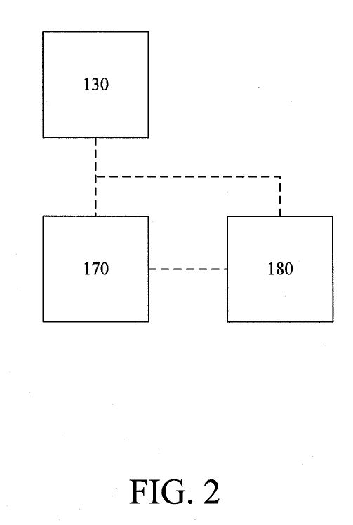

As mentioned above, an imaging device 130 may obtain images of molten liquid (ML) to facilitate determination of molten liquid (ML) content. In one embodiment, the system 100 is configured to automatically determine molten liquid (ML) content. For example, and with reference now to FIG. 2, the imaging device 130 may be in communication with an image processor 170 and/or a data analyzer 180. The imaging device 130 may communicate the obtained images to the image processor 170, which may be configured to convert at least some of the images into imaging data. The image processor 170 may communicate the imaging data to the data analyzer 180, which may be configured to analyze the imaging data associated with the images to determine when the imaging data is representative of a predetermined amount of electrolyte in the molten liquid. When the data analyzer 180 determines the imaging data is representative of a predetermined amount of electrolyte in the molten liquid, the switch 160 may be activated. The imaging device 130, the image processor 170 and/or the data analyzer 180 may be at the same location or may be located at different locations relative to one another. The image processor 170, the data analyzer 180 and/or the imaging device 130 may be separate components or may be integral with one another and/or other components. In other words, the imaging device 130, image processor 170 and/or data analyzer 180 may be in any arrangement suitable to enable communication of images and/or imaging data to facilitate determination of molten liquid (ML) content. Further, the images and/or imaging data may be communicated electrically and/or optically such as via any of wired, wireless, fiber optics, lasers, and/or solid state technology, to name a few.

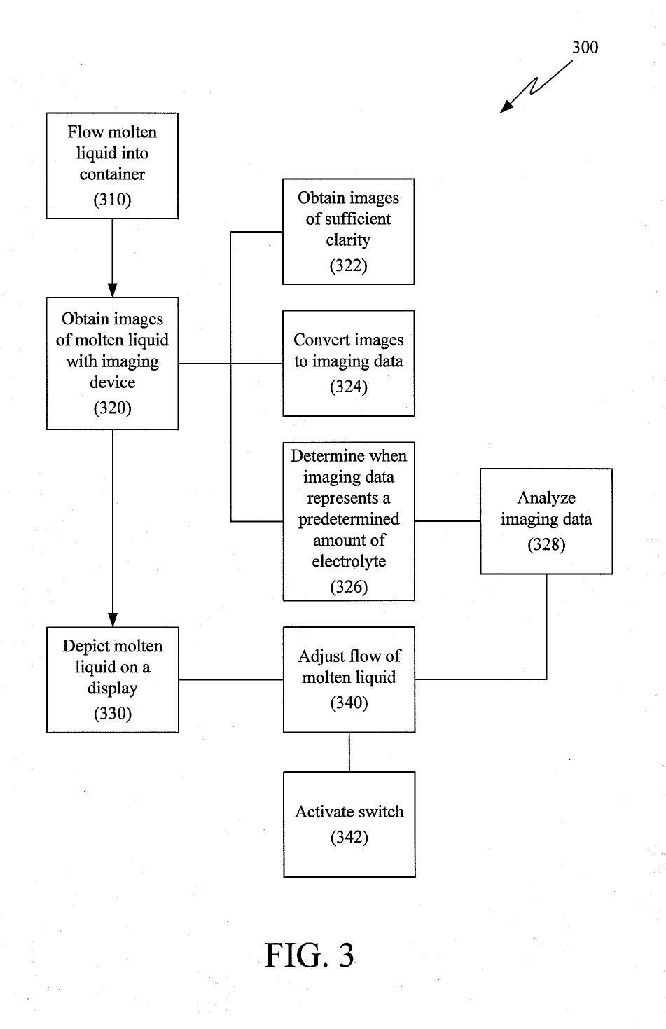

Methods relating to viewing and obtaining images of liquid while tapping an electrolysis cell are provided. In one embodiment, and with reference to FIG. 3, a method (300) includes the steps of flowing molten liquid into a container (310), obtaining images of the molten liquid with an imaging device as the molten liquid enters the container (320), and depicting, on a display, the molten liquid via the images obtained by the imaging device (330).

The obtaining step (320) may include obtaining images of sufficient clarity to enable discernment between transition of the molten liquid from a first type of liquid to a second type of liquid (322). Additionally, this obtaining step (320) may include converting at least some of the images into imaging data (324), and determining when the imaging data is representative of a predetermined amount of electrolyte in the molten liquid (326). This determining step (326) may include analyzing the imaging data associated with the images (328). The analyzing step (328) may result in adjusting the flow of molten liquid into the body of the container (340), such as via activation of a switch (342). In turn, tailored removal of molten liquids may be facilitated.

With respect to the depicting step (330), when the molten liquid transitions from a first type of liquid (e.g., molten metal) to a second type of liquid (e.g., electrolyte), this depicting step (330) may result in adjusting the flow of molten liquid into the body of the container (340). This adjusting step (340) may include activating a switch (342) proximal the display via an operator viewing the display. In turn, tailored removal of molten liquids may be facilitated.

### EXAMPLES

### Example 1

### Molten Liquid Removal

A system similar to that of FIG. 1, but without the camera and display is used to remove liquids from an aluminum electrolysis cell. As the liquid is removed, the operator endeavors to view the molten liquid as it enters the container via the passageway and the naked eye. When the operator determines via the naked eye that the liquid contains some electrolyte, the operator adjusts and/or terminates the incoming liquid flow rate with the goal of including less than 150 pounds of bath per 15,000 pounds of metal in the final recovered product. The amount of metal and bath (in pounds) extracted from aluminum electrolysis cells per day during four days using this system is provided in Table 1, below.

TABLE 1
Total Amount of Metal and Bath Extracted Per Day - Using Naked Eye

| | Amount of | Amount of | |
|---|---|---|---|
| | Extracted | Extracted | Percent Bath in the |
| Date | Metal (lbs.) | Bath (lbs.) | Extracted Liquid |
| Day 1 | 157,760 | 4280 | 2.64% |
| Day 2 | 176,580 | 5220 | 2.87% |
| Day 3 | 158,590 | 2830 | 1.75% |
| Day 4 | 208,500 | 4470 | 2.10% |
| TOTAL | 701,430 | 16,800 | 2.34% |

On average, the extracted liquid contained about 2.34% bath using experienced operators. With inexperienced operators, it is not unusual to see the amount of bath extracted exceed 5,000 lbs per shift. Thus, these numbers would be expected to be higher for inexperience operators.

Data relating to the variation in the amount of bath per container is also provided below in Table 2.

TABLE 2
Variation in Amount of Bath Per Container Per Day - Using Naked Eye

| | No. | Ave Bath Per | Maximum Bath In Any |
|---|---|---|---|
| Date | Containers | Container (lbs.) | One Container (lbs.) |
| Day 1 | 11 | 389.1 | 890 |
| Day 2 | 12 | 435 | 2280 |
| Day 3 | 11 | 257.3 | 790 |
| Day 4 | 14 | 319.3 | 1250 |

### Example 2

### Molten Liquid Removal Using Display System

A system similar to that of FIG. 1 is used to remove liquids from an aluminum electrolysis cell. As the liquid is removed, the operator views the molten liquid as it enters the container via a display, which is connected to a camera viewing the molten liquid via the passageway. When the operator determines via the display that the liquid contains some electrolyte, the operator adjusts and/or terminates the incoming liquid flow rate with the goal of including less than 150 pounds of bath per 15,000 pounds of metal. The amount of metal and bath (in pounds) extracted from aluminum electrolysis cells per day during four days using this system is provided in Table 3, below.

TABLE 3
Total Amount of Metal and Bath Extracted Per Day - Using
Camera and Display

| | Amount of | | |
|---|---|---|---|
| | Extracted | Amount of Extracted | Percent Bath in the |
| Date | Metal (lbs.) | Bath (lbs.) | Extracted Liquid |
| Day 1 | 180560 | 1760 | 0.97% |
| Day 2 | 150990 | 3340 | 2.16% |
| Day 3 | 174620 | 2240 | 1.27% |
| Day 4 | 173230 | 2690 | 1.53% |
| TOTAL | 679400 | 10030 | 1.45% |

On average, the extracted liquid using the new system contains about 1.45% bath using inexperienced operators. It is expected that experience operators would produce better results. Overall, the system with the display realizes nearly a 1% decrease in the amount of bath extracted. This is a significant decrease and will facilitate savings in both electrolysis cell operations and downstream metal recovery operations. The variability of the amount of bath extracted also decreases, as illustrated in Table 4, below.

TABLE 4
Variation in Amount of Bath Per Container Per Day - Using
Camera and Display

| | No. | Ave Bath Per | Maximum Bath In Any One |
|---|---|---|---|
| Date | Containers | Container (lbs.) | Container (lbs.) |
| Day 1 | 12 | 146.7 | 550 |
| Day 2 | 11 | 303.6 | 800 |
| Day 3 | 11 | 203.6 | 910 |
| Day 4 | 12 | 224.2 | 680 |

The average bath per container per day ranges from about 147 pounds to about 304 pounds, which is much less than the range of about 257 to 435 pounds realized by the system not utilizing the display. Furthermore, the maximum amount of bath in any one container decreases. The average maximum for the four days using the camera and display is 735 pounds, while the system using the naked eye realizes an average maximum of about 1303 pounds—i.e., a decrease of nearly 600 pounds by the system with the camera and display. Thus, the system using the camera and display decreases both the variability and average amounts of bath extracted from the aluminum electrolysis cells.

As may be appreciated, many of the above-described systems and/or apparatus may be utilized in conjunction with many of the above-described methods, and vice-versa, and any of such useful combinations are expressly within the scope and spirit of the present disclosure. Furthermore, while the systems, methods and apparatus of the present disclosure have been generally described relative to aluminum electrolysis cells, it is contemplated that the systems, methods and apparatus of the present disclosure could be utilized with various other electrolysis cell types, such as, without limitation, lead, magnesium, zinc, zirconium, titanium and silicon electrolysis cells, as appropriate. Additionally, while the tailored removal of molten metal has been described, it is anticipated that the system could also be used in reverse order so as to facilitate tailored removal of electrolyte.

While various embodiments of the present disclosure have been described in detail, it is apparent that modifications and adaptations of those embodiments will occur to those skilled in the art. However, it is to be expressly understood that such modifications and adaptations are within the spirit and scope of the present invention.

1. A system comprising:
(a) a container adapted to contain molten liquid of an electrolysis cell, wherein the molten liquid comprises at least one of molten metal and electrolyte;
(b) a passageway adapted to view the molten liquid as it enters the container;
(c) an imaging device facing the passageway, wherein the imaging device is adapted to obtain images of the molten liquid, via the passageway, as the molten liquid enters the container; and and
(d) a display in communication with the imaging device, wherein the display is adapted to depict the molten liquid via the images obtained by the imaging device.

2. The system of claim 1, wherein the passageway is proximal a top portion of the container.

3. The system of claim 2, wherein the passageway is integral with a portion of the container.

4. The system of claim 1, wherein the passageway comprises:
a first portion having a first diameter; and
a second portion having a second diameter;
wherein the first diameter is bigger than the second diameter.

5. The system of claim 4, wherein the first diameter is proximal the inside of the container; and
wherein the second diameter is proximal the outside of the container;
wherein the ratio of the first diameter to the second diameter is from about 0.25:1 to about 20:1.

6. The system of claim 5, wherein the passageway is between the imaging device and the molten liquid; and
wherein the imaging device is adapted to obtain images of the molten liquid as viewed via the first and second portions of the passageway;
wherein the images are of sufficient clarity to enable discernment between transition of the molten liquid from a first type of liquid to a second type of liquid.

7. The system of claim 6, wherein the first type of liquid is molten metal, and wherein the second type of liquid is electrolyte.

8. The system of claim 7, further comprising:
a switch configured to adjust the flow of molten liquid into the container.

9. The system of claim 8, wherein the switch is located proximal the display such that an operator may activate the switch while viewing the display.

10. The system of claim 8, further comprising:
an image processor in communication with the imaging device;
wherein the image processor is configured to receive images obtained by the imaging device;
wherein the image processor is configured to convert at least some of the images into imaging data; and
wherein a data analyzer is configured to analyze the imaging data associated with the images and determine when the imaging data is representative of a predetermined amount of electrolyte in the molten liquid.

11. The system of claim 10, wherein the switch is in communication with at least one of the imaging device, the image processor, and the data analyzer; and
wherein the switch is activated when the data analyzer determines that the imaging data is representative of a predetermined amount of electrolyte in the molten liquid.

12. The system of claim 1, wherein the passageway is at an angle relative to the top surface of the molten liquid within the container such that the molten liquid can be viewed via the passageway.

13. A method comprising:
(a) flowing molten liquid of an electrolysis cell into a container, and wherein the molten liquid comprises at least one of molten metal and electrolyte;
(b) obtaining images of the molten liquid via an imaging device as the molten liquid enters the container; and
(c) depicting, on a display, the molten liquid via the images obtained by the imaging device.

14. The method of claim 13, wherein the obtaining step comprises:
focusing an imaging device through a passageway containing a first portion and a second portion, wherein the first portion of the passageway comprises a different diameter than the second portion of the passageway.

15. The method of claim 14, wherein the obtaining step comprises:
obtaining images of sufficient clarity to enable discernment between transition of the molten liquid from a first type of liquid to a second type of liquid.

16. The method of claim 13, comprising:
adjusting, in response to the depicting step (c), the flow of molten liquid into the container when the molten liquid transitions from a first type of liquid to a second type of liquid.

17. The method of claim 16, wherein the adjusting step comprises:
activating a switch proximal the display via an operator viewing the display.

18. The method of claim 13, wherein the obtaining step comprises:
converting at least some of the images into imaging data; and
determining when the imaging data is representative of a predetermined amount of electrolyte in the molten liquid.

19. The method of claim 18, wherein the determining step comprises:
analyzing the imaging data associated with the images.

20. The method of claim 19, comprising:
adjusting, concomitant to the determining step, the flow of molten liquid into the container.
